(19) United States
(12) Patent Application Publication
(10) Pub. No.: US 2003/0024126 A1
(43) Pub. Date: Feb. 6, 2003

(54) Snap-assembling structure of a grip for grill tools

(76) Inventor: Te-Ching Liu, Taipei (TW)

Correspondence Address: TE-CHING LIU, P.O. Box 96-405, Taipei 106, TW

(21) Appl. No.: 09/922,575

(22) Filed: Aug. 3, 2001

(51) Int. Cl. B25G 3/12

(52) U.S. Cl. 30/340

(57) ABSTRACT

A snap-assembling structure of a grip for grill tools, which comprises a connection handle having two side plates, and both side plates are furnished with catch cuts respectively; the casing is furnished with a plug slot and a push button channel for receiving a push button mounted with a spring; after the connection handle is plugged in place, press the push button to have the cylindrical parts separated from the catch cuts of the connection handle so as to enable the connection handle to move freely along the plug slot; as soon as the catch cut of the connection handle aligns with the push button channel, the spring will push the push button into the catch cuts of the connection handle to prevent the connection handle from moving, i. e., to be caught in position.

### BACKGROUND OF THE INVENTION

1. Field of the Invention

This invention relates to grill tools, and particularly to a snap-assembling structure of a grip for grill tools.

2. Description of the Prior Art

In the conventional grill tools, every tool includes a grip and a connection handle or connection bar, having a suitable length so as to prevent the hand from being burned as a result of being too close to the grill or the fire; however, the elongate grip would take more space upon being stored aside from the inconvenience during shipping.

### SUMMARY OF THE INVENTION

The prime object of the present invention is to provide a grill tool, in which the side plates of the connection handle are furnished with catch cuts respectively; the connection handle is plugged into two parallel sliding slots in the grip; one end of the casing of the grip is furnished with a push button mounted with a spring; after the connection handle is pulled out, and is caught with a push button in the grip, it will be caught in a position; the grip can be pulled out at a given length so as to separate from the grill or the fire.

Another object of the present invention is to provide a grill tool, in which both ends of the connection handle are furnished with catch cuts respectively; the catch cut can be engaged with the push button automatically; when the push button is pressed, the connection handle can be moved along the sliding slots of the grip; as soon as the catch cuts of the connection handle is moved over the push button, the catch necks of the push button will be engaged in place automatically with the catch cuts of the connection handle as a result of the force of the spring.

Still another object of the present invention is to provide a grill tool, in which the side plates on both ends of the connection handle are furnished with catch cuts respectively; the catch cuts and the push button can be engaged together automatically; by means of the catch cuts on the side plates of the connection handle, the connection handle can be pulled out at the maximum length so as to separate from the grill or the fire; the connection handle can be retracted to the minimum length to facilitate storage.

A further object of the present invention is to provide a grill tool, in which the push button mounted in the casing of the grip has a push bar, of which one end extends out of the push button; the push bar is furnished with two symmetrical flat surfaces on both sides thereof; the flat surfaces of the push bar can be moved along the vertical channel on outer end of the lateral slot so as to enable the push button to move in a regular direction, and to prevent the elongate push button from rotation unintentionally.

A still further object of the present invention is to provide a grill tool, in which the lateral slot in the casing of the grip is divided into two portions with a partition plate; the upper part of the partition plate has a U-shaped channel; the push button has a short bar to be mounted in the U-shaped channel; both sides of the short bar are furnished with a cylindrical part and a positioning cylinder with a larger diameter; the cylindrical part is mounted with a spring, of which both ends are pushed against the partition plate and the positioning cylinder so as to provide the push button with a pushing-out force; the push bar of the push button extends out of the casing of the grip.

Yet another object of the present invention is to provide a grill tool, in which the push button mounted in the lateral slot of the casing has a push bar, which is furnished with two cuts; the width between the two cuts is equal to that between the two parallel sliding slots of the casing; when the push button is pressed, and when the two cuts of the push button are aligned with the two sliding slots, the catch cuts of the connection handle will be released from the push button so as to be moved back and forth, or pulled out freely.

### BRIEF DESCRIPTION OF THE DRAWINGS

FIG. 1 is a perspective view of the present invention, showing a fork being recovered for storage.

FIG. 2 is a perspective view of the present invention, showing a fork being used normally.

FIG. 3 is a disassembled view of the present invention, showing the mounting position of a push button.

FIG. 4 is a sectional view of the present invention, showing the snap-assembling connection structure between the connection handle and the push button.

FIG. 5 is a sectional view of the present invention, showing a sectional structure along a line 5-5 as shown in FIG. 4.

FIG. 6 is a sectional view of the present invention, showing the moved condition of the connection handle.

FIG. 7 is a perspective view of the present invention, showing a shovel in package condition.

FIG. 8 is a perspective view of the present invention, showing tongs in package condition.

### DETAILED DESCRIPTION OF THE PREFERRED EMBODIMENTS

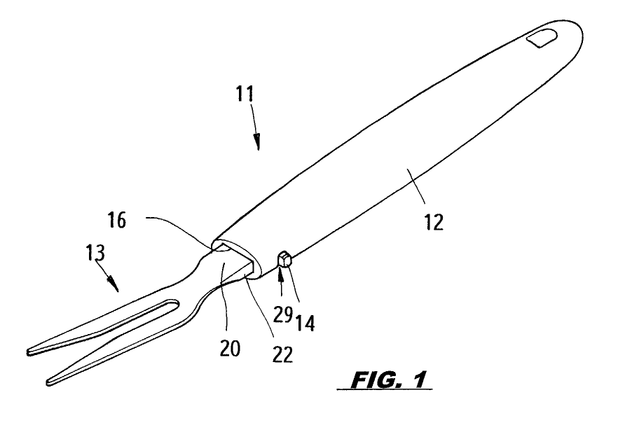

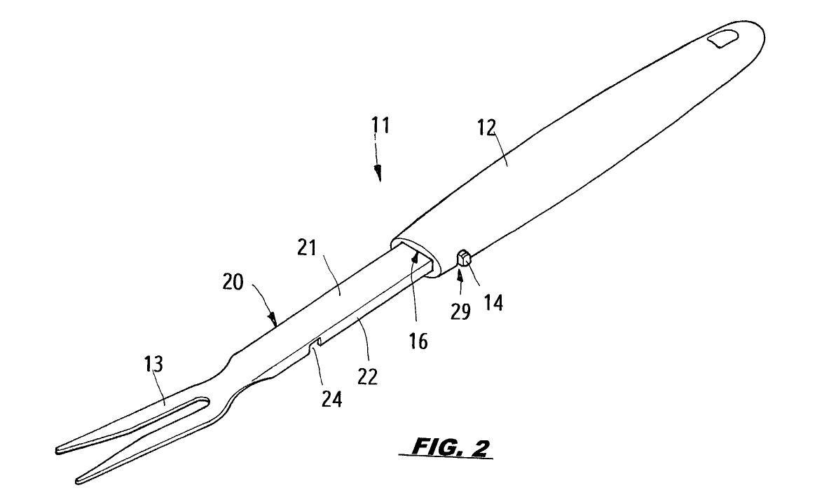

This invention relates to a snap-assembling structure of grip for grill tools, referring to FIGS. 1 and 2, a connection handle 20 of a fork 13 for grill tools 11 is plugged into a plug slot 16 of a grip 12; one side of the grip 12 is furnished with a lateral slot 29 for receiving a push button 14. The inside of the push button 14 is furnished with resilient parts so as to provide he push button 14 with a pushing-out force normally. Before pulling the side plate 22 of the grill tool 11, press the push button 14 so as to release the connection handle 20 from the push button 14, and to push the connection handle 20 in or out

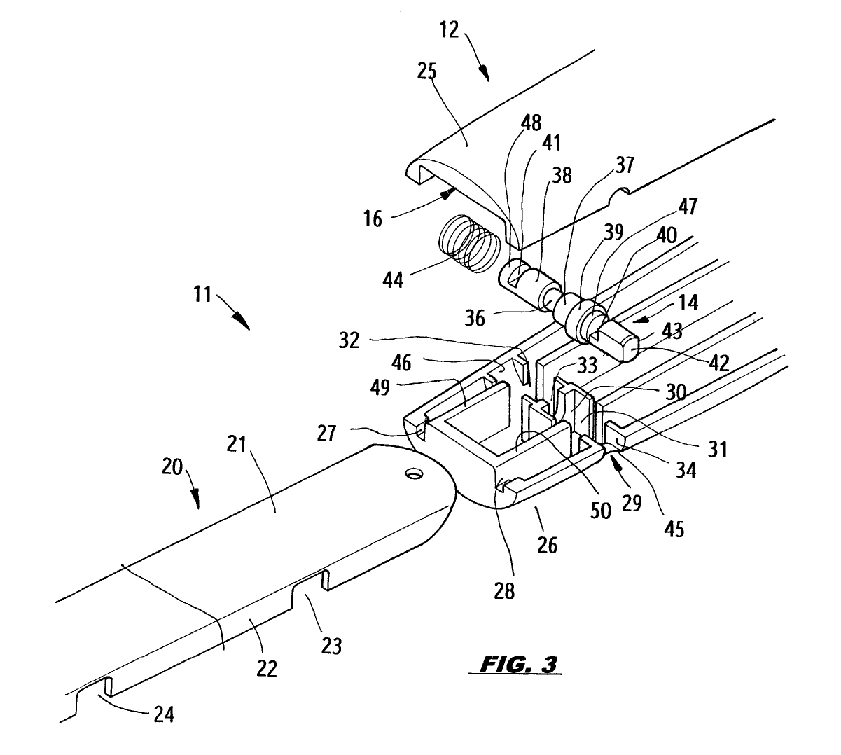

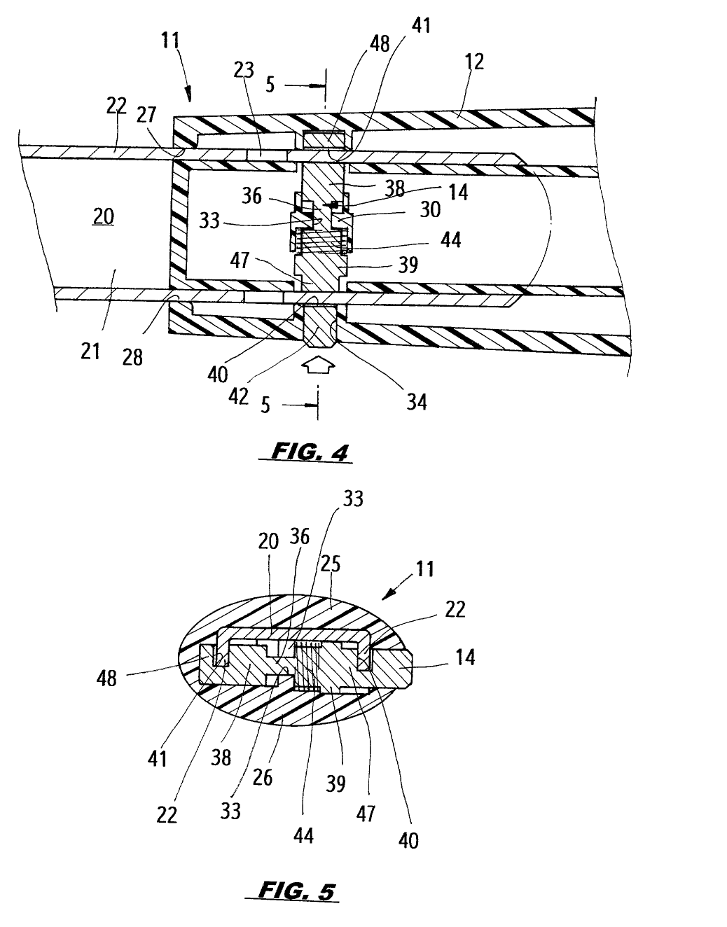

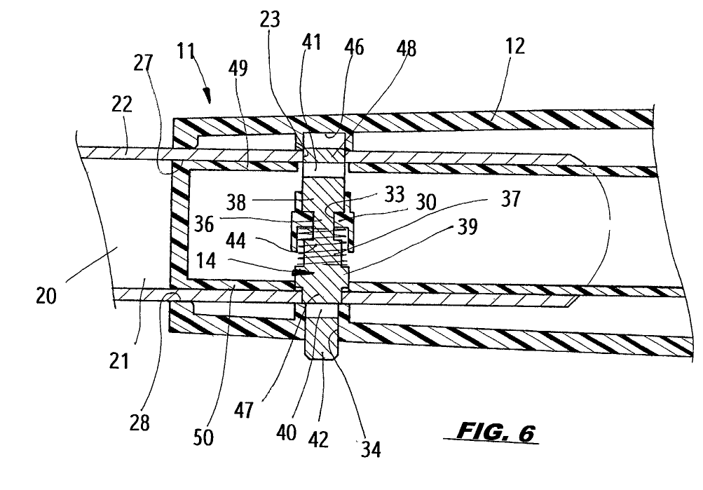

Referring to FIGS. 1 to 6, the connection handle 20 of a fork 13 of the grill tool 1 1 is substantially a U-shaped member with a wide flat plate 21; both sides of the flat plate 21 are furnished with two symmetrical side plates 22 respectively. Each of the side plates 22 is furnished with two catch cuts 23 and 24. The U-shaped connection handle 20 is to be plugged into a plug slot 16 of the grip 12. The grip 12 includes two flat oblong-shaped casings 25 and 26; one end of the grip 12 is furnished with a lateral slot 29 for receiving a push button 14 and a spring 44; the spring 44 is used for providing the push button 14 with a pushing-out force so as to facilitate the connection handle 20 in the plug slot 16 of the grip 12 to move along two parallel sliding slots 27 and 28 of the plug slot 16 in the grip 12. As soon as one of the catch cuts 23 and 24 on the side plate 22 catches the push button 14, the push button 14 will engage with the catch cut as a result of the pushing force of the spring 44, and the connection handle 20 will be retained in place without moving. As soon as the push button 14 is pressed down, the catch necks 47 and 48 of the push button 14 will be moved out of the catch cut 23 (or 24) of the side plate 22 of the connection handle 20; then, the connection handle 20 can be move freely.

The grip 12 includes two casings 25 and 26, a push button 14 and a spring 44; the two casings 25 and 26 are assembled together as one piece; one end of the grip 12 has a U-shaped plug slot 16, of which both sides are furnished with two parallel sliding slots 27 and 28 respectively. One end of the casing 26 is furnished with two parallel wall plates 49 and 50, which are to be engaged with the two side plates 22 of the connection handle 20 so as to facilitate the two side plates to move back and forth. The end of the plug slot 16 of the grip 12 has a lateral slot 29, of which the center has a partition plate 30 with a U-shaped channel 33 to divide the lateral slot 29-into two mounting channels 31 and 32; the outer end of the mounting channel 32 is a closed end 46, while the outer end of the mounting channel 31 is an opening end 45, of which the inside is furnished with a vertical channel 34 for receiving a push bar 42 that has a flat surface 43; when the push button 14 is pressed, it can move in a regular direction without rotation unintentionally.

The push button 14 is mounted in the lateral slot 29 of the casing 26, and the center thereof has a short bar 36, of which the diameter is equal to that of the lower edge of the U-shaped channel 33 of the partition plate 30, and the length thereof is longer than the thickness of the partition plate 30. Both ends of the short bar 36 are furnished with cylindrical parts 37 and 38 with larger diameter respectively; one end of the cylindrical part 37 has a positioning cylinder 39 with a larger diameter, and outer end thereof is furnished with a catch neck 47, a cut 40 and a push bar 42. The cylindrical part 38 on other end of the short bar 36 is furnished with a cut 41 and a catch neck 48; before the push button 14 is mounted in the lateral slot 29 of the casing 26, a spring 44 is mounted on cylindrical part 37; one end of the spring 44 in contact with the positioning cylinder 39; after the push button 14 is mounted in the lateral slot 29, the other end of the spring 44 pushes against the partition plate 30. After the two casings 25 and 26 are assembled together, the spring 44 will normally push the push bar 42 of the push button 14 outwards.

The push button 14 is furnished with two cuts 40 and 41, between which the distance is equal to that between two sliding slots 27 and 28 outside the two parallel wall plates 49 and 50 of the casing 26. When the push button 14 is pressed, the two parallel slots 40 and 41 will be pushed to align with the two parallel sliding slots 27 and 28 respectively so as to enable the side plates 22 of the connection handle 20 to slide back and forth; beside both sides of the two cuts 40 and 41, two catch necks 47 and 48 are furnished respectively. The catch necks 47 and 48 are used to disengage from catch cut 23 or 24 of the side plates 22 of the connection handle 20 upon the push button 14 being pressed; when the push button 14 is not pressed down, the push button 14is pushed towards the opening end 45 of the lateral slot 29 as a result of the pushing force of spring 44. After the push button 14 is pressed and the connection handle 20 is pulled to move, the catch cut 23 or 24 of the side plates 22 would engage with the cuts 40 and 41; then, the catch necks 47 and 48 will engage with the catch cut 23 (or 24) automatically for positioning so as to prevent the connection handle 20 from moving.

The casing 25 is to be assembled with the casing 26 to form into a grip 12 with a plug slot 16, and the plug slot 16 is a multi-side slot, which extends into the grip in a given depth. The lateral slot 29 formed with the two casings 25 and 26 has a given cover area, and after the two casings are assembled together, the push button 14 is limited to move within the lateral slot 29 freely.

The lateral slot 29 in the casing 26 is mounted with a push button 14 and a spring 44; after the casing 26 is assembled together with the casing 25, a single grip 12 is formed in shaped. By means of the pushing force of the spring 44, the push bar 42 of the push button 14 is pushed to the opening end 45 of the lateral slot 29 normally so as to facilitate the push bar 42 to move inwards upon the push button 14 being pressed.

One end of the grip 12 has a U-shaped plug slot 16 for receiving a connection handle 20 of the grill tools; one end of the connection handle 20 is a round end to facilitate it to guide and plug into the plug slot 16. After the round end of the connection handle 20 is plugged into the plug slot 16, the end of the side plate 22 will contact with the catch necks 47 and 48 in the lateral slot 29 without moving further; then, press the push bar 42 of the push button 14 inwards, the side plate 22 of the connection handle 20 will slide along the two cuts 40 and 41 so as to have the connection handle 20 entered the inner space of the two sliding slots 27 and 28. When the catch cut 23 of the side plate 22 moves to the catch necks 47 and 48, the catch necks 47 and 48 will hold the catch cut 23 of side plate 22 immediately as a result of the push force of the spring 44, and the connection handle 20 will be stopped. When the push bar 42 of the grip 12 is pressed again, the connection handle 20 can be moved inwards again until the catch cut 24 being engaged with the catch necks 47 and 48; then, the connection handle 20 will be caught and positioned in place by means of the push button 14.

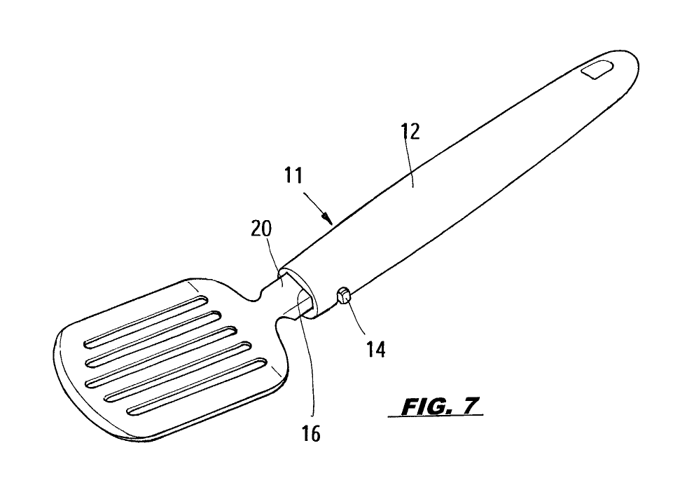

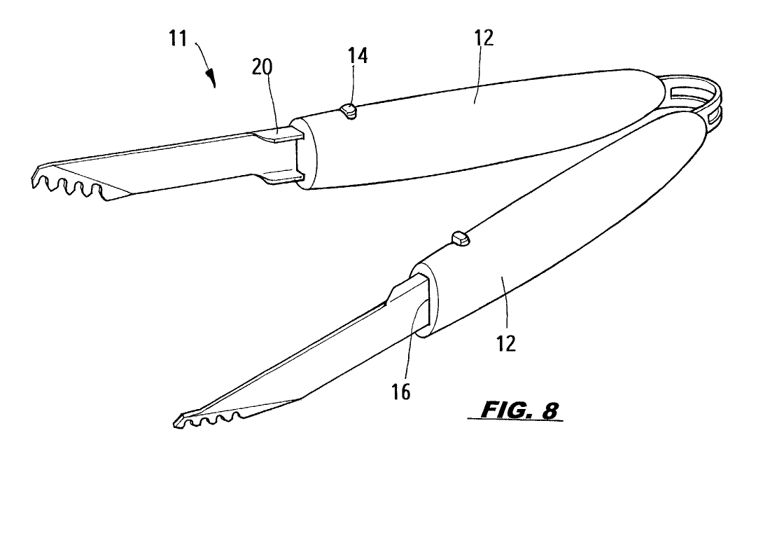

As shown in FIG. 7, the grip 12 with a push button 14 is the same as that mentioned above; the front end of the grip 12 has a plug slot 16 for receiving the connection handle 20 of a cooking shovel; the length of the connection handle 20 can be adjusted by means of the push button 14. As shown in FIG. 8, the tail ends of two grips 12 can be connected together by means of a U-shaped plate; the front ends of the two grips 12 are furnished with plug slots 16 respectively for receiving two tongs; the length of the two connection handles 20 can be adjusted if necessary.

According to the present invention, the grip 12 includes a push button 14 and a plug slot 16 for receiving a connection handle 20 of a grill tool 11; the connection handle 20 can be pulled out to the maximum length so as to separate from the grill and the fire as far as possible; the connection handle 20 can be retracted to the minimum length so as to facilitate the grill tool 11 to be stored up. Through the aforesaid description of the embodiment, the features and the structure of the present invention have been disclosed completely; it is apparent that the present invention has provided an obvious improvement in the grill tools, and the improvement is never anticipated and achieved by any person in the field; therefore, the structure of the present invention is deemed unique.

What is claimed is:

1. A snap-assembling structure of a grip for grill tools, comprising
a grip including two casings, and having a—shaped plug slot for receiving a connection handle of a grill tool; one end of said grip furnished with a lateral slot for mounting a push button; center of said lateral slot furnished with a partition plate to divide said slot into two portions for mounting a push button with a spring therein; one end of said push button extended out of an opening end of said lateral slot,
a grill tool having a suitable length, and having a U-shaped connection handle to be plugged in a plug slot in said grip; said connection handle having two side plates with two catch cuts respectively;
a push button in cylindrical shape, and center thereof having a short bar, of which both sides furnished with two cylindrical parts having a larger diameter respectively; one of said cylindrical parts having a positioning cylinder mounted with a spring; said cylindrical parts furnished with two cuts having same width as that of a plug slot in said grip; two catch necks furnished beside said two cuts respectively;
a spring mounted on said cylindrical part under said positioning cylinder, and then said spring and said push button being mounted in a lateral slot; one end of said spring pushing against said positioning cylinder, while other end thereof pushing against a partition plate in middle of said lateral slot

2. A snap-assembling structure of a grip for grill tools as claimed in claim 1, wherein two casings of said grip are assembled together flatly; two sliding slots furnished on both sides of said U-shaped plug slot respectively; two wall plates furnished and extended into said casing so as to facilitate said two side plates to move along said parallel wall plates.

3. A snap-assembling structure of a grip for grill tools as claimed in claim 1, wherein said push button mounted in said lateral slot is furnished with two symmetrical flat surfaces on both sides of a push bar so as to facilitate said push bar to move back and forth in a vertical channel in a regular direction.
